(19) United States
(12) Patent Application Publication
(10) Pub. No.: US 2010/0262906 A1
(43) Pub. Date: Oct. 14, 2010

(54) ELECTRONIC DEVICE AND METHOD FOR PROCESSING DATA THEREOF

(75) Inventor: YU-LUN LI, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/619,778

(22) Filed: Nov. 17, 2009

(30) Foreign Application Priority Data
Apr. 8, 2009 (CN) 200910301426.X

(51) Int. Cl. G06F 3/01; G06F 3/048

(52) U.S. Cl. 715/702; 345/179; 345/179; 715/770

(57) ABSTRACT

An electronic device and method for processing data include detecting a touch action of a stylus on a touch panel to select data to be processed in the electronic device, and sending a preset instruction recorded in an actuated function key of the stylus to a signal receiver in response that a function key has been actuated. The electronic device and method further include receiving the preset instruction by the signal receiver, and executing the preset instruction to process the selected data.

### BACKGROUND

1. Technical Field

Embodiments of the present disclosure relate to data managing, and more particularly to an electronic device and a method for processing data in the electronic device.

2. Description of Related Art

Electronic devices provide multiple features to process data stored in the electronic devices, such as the ability to cut and paste data, and the ability to modify data, for example. However, these features are only available from one or more pull-down menus. Thus, it is not convenient for people to process the data.

What is needed, therefore, is an improved electronic device and method for processing data in the electronic device conveniently.

### BRIEF DESCRIPTION OF THE DRAWINGS

FIG. 1 is a block diagram of one embodiment of an electronic device.

FIG. 2 is a schematic diagram of one embodiment of processing data using the electronic device of FIG. 1.

FIG. 3 is a flowchart of one embodiment of a method for processing data in the electronic device of FIG. 1.

FIG. 4 is a flowchart of one embodiment of a method for copying data in the electronic device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

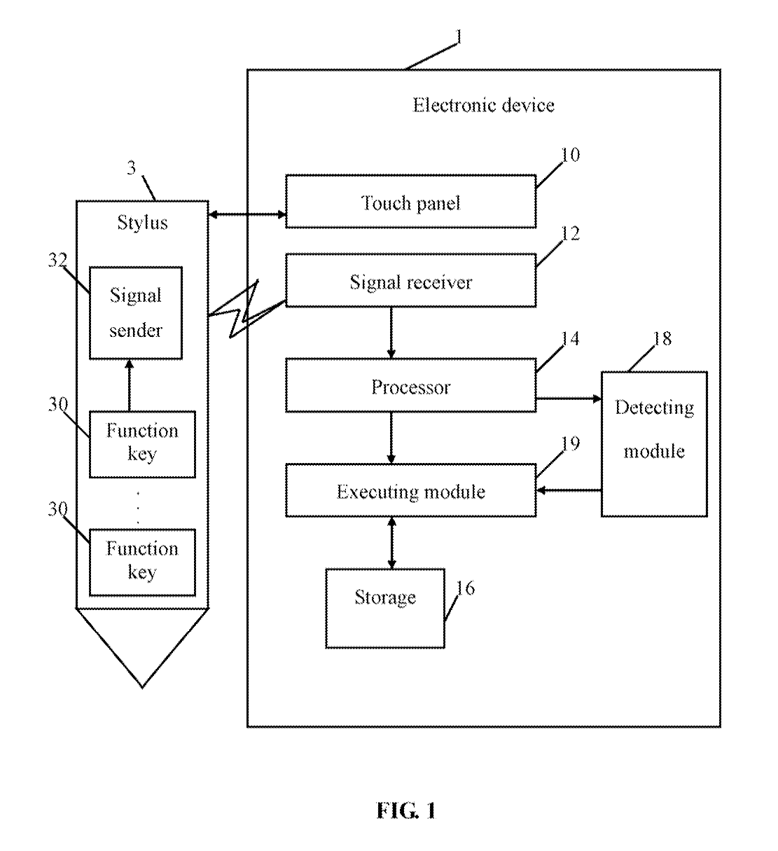

FIG. 1 is a block diagram of one embodiment of an electronic device 1. The electronic device 1 includes a touch panel 10, a signal receiver 12, and a stylus 3. The stylus 3 includes a signal sender 32 and one or more function buttons/switch/keys 30 (hereinafter referred to as “function key(s) 30”). The electronic device 1 may process data by utilizing the stylus 3. Data in the electronic device 1 is selected using the stylus 3. When a function key 30 (e.g., a copy key) has been actuated, the signal sender 32 sends a preset instruction (e.g., a copy instruction) of the actuated function key 30 to the signal receiver 12, and then the electronic device 1 executes the preset instruction to process (e.g., copy) the selected data. The signal sender 32 and the signal receiver 12 may establish a communication between the stylus 3 and the electronic device 1.

In one embodiment, the one or more function keys 30 of the stylus 3 record preset instructions, such as a copy key recording a copy instruction, a paste key recording a paste instruction, a cut key recording a cut instruction, and/or a deletion key recording a deletion instruction, for example. The one or more function keys 30 may be press keys or slide buttons/switches.

The electronic device 1 may also include a processor 14 and a storage 16. In one embodiment, the electronic device 1 may be a mobile phone, a personal digital assistant, a handheld computer, or any other kind of computing device. The processor 14 executes one or more computerized operations of the electronic device 1 and other applications, to provide functions of the electronic device 1. The storage 16 stores one or more programs, such as programs of an operating system, other applications of the electronic device 1, and various kinds of data, such as files, contact information, communication data, for example. In one embodiment, the storage 16 may be a memory of the electronic device 1 or an external storage device, such as a memory stick, a subscriber identification module (SIM) card, a smart media card, a compact flash card, or any other type of memory card.

In one embodiment, the electronic device 1 further includes a detecting module 18 and an executing module 19. The modules 18 and 19 may comprise one or more computerized codes to be executed by the processor 14 to perform one or more operations of the electronic device 1. Details of these operations will be provided below.

The detecting module 18 detects a touch action of the stylus 3 on the touch panel 10 to select data to be processed in the storage 16. The data may be a document, contact data in a contact list, or a communication record, for example.

A function key 30 of the stylus 3 may be actuated to process the selected data. The signal sender 32 sends a preset instruction recorded in the actuated function key 30 to the signal receiver 12. Further details will be provided below.

The signal receiver 12 receives the preset instruction from the signal sender 32. The executing module 19 executes the preset instruction to process the selected data.

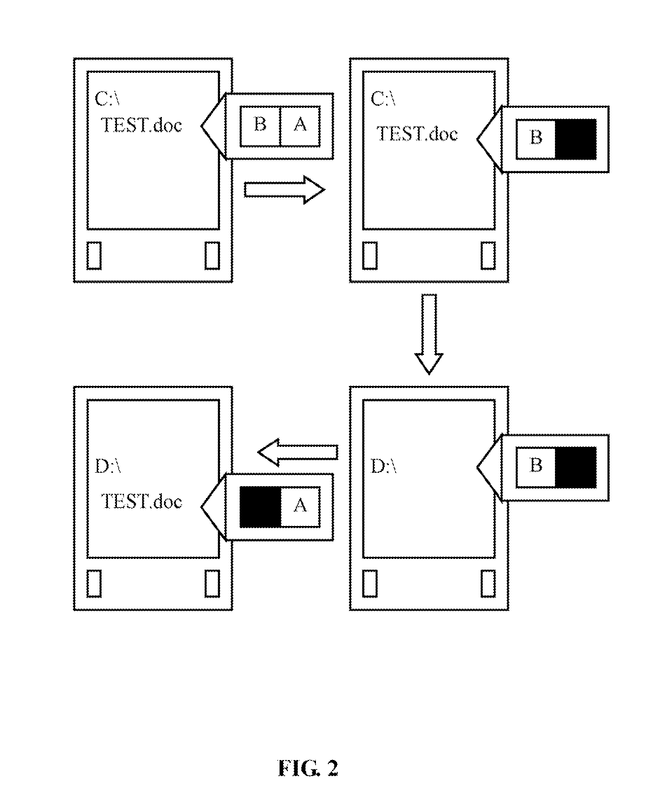

In one embodiment as shown in FIG. 2, a document named as “test” is detected to be selected by the stylus 3. A function key “A” has been actuated. The function key “A” may be a copy key, for example. The signal sender 32 sends a copy instruction recorded in the copy key to the signal receiver 12. The signal receiver 12 receives the copy instruction, and the executing module 19 executes the copy instruction to copy the “test” document. For example, the executing module 19 may copy the “test” document on a clipboard of the electronic device 1.

The detecting module further detects a touch action of the stylus 3 on the touch panel 10 to select a target storage path (e.g., D:\). A function key “B” has been actuated. The function key “B” may be a paste key, for example. The signal sender 32 sends a paste instruction recorded in the paste key to the signal receiver 12. The signal receiver 12 receives the paste instruction, and the executing module 19 executes the paste instruction to paste the “test” document into the storage 16 according to the target storage path (e.g., D:\).

By utilizing the above mentioned components and/or modules in the electronic device 1, various data may be processed easily without selecting functions/options from many pull-down menus.

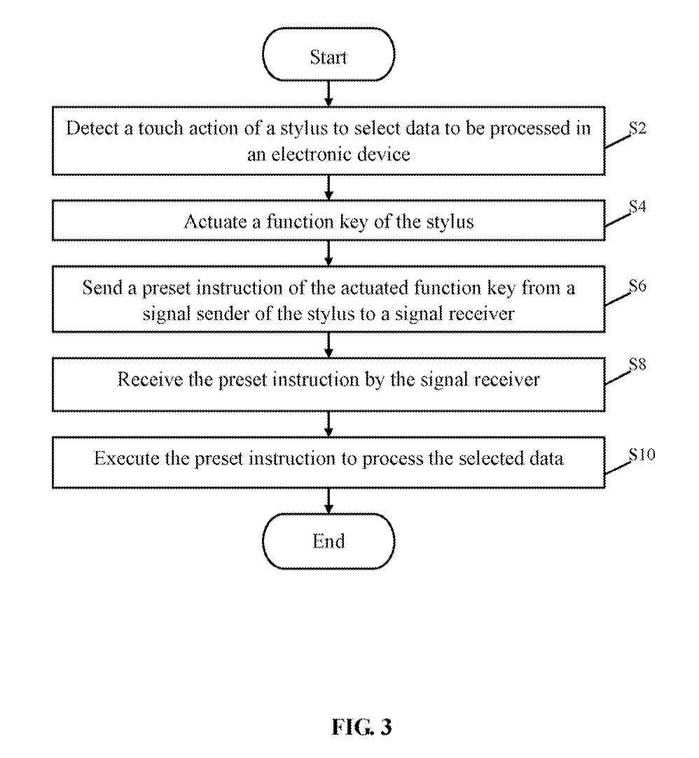

FIG. 3 is a flowchart of one embodiment of a method for processing data in the electronic device 1 of FIG. 1. Depending on the embodiment, additional blocks may be added, others removed, and the ordering of the blocks may be replaced.

In block S2, the detecting module 18 detects a touch action of the stylus 3 on the touch panel 10 to select data to be processed in the storage 16.

In block S4, a function key 30 has been actuated for processing the selected data.

In block S6, the signal sender 32 sends a preset instruction recorded in the actuated function key 30 to the signal receiver 12.

In block S8, the signal receiver 12 receives the preset instruction from the signal sender 32.

In block S10, the executing module 19 executes the preset instruction to process the selected data.

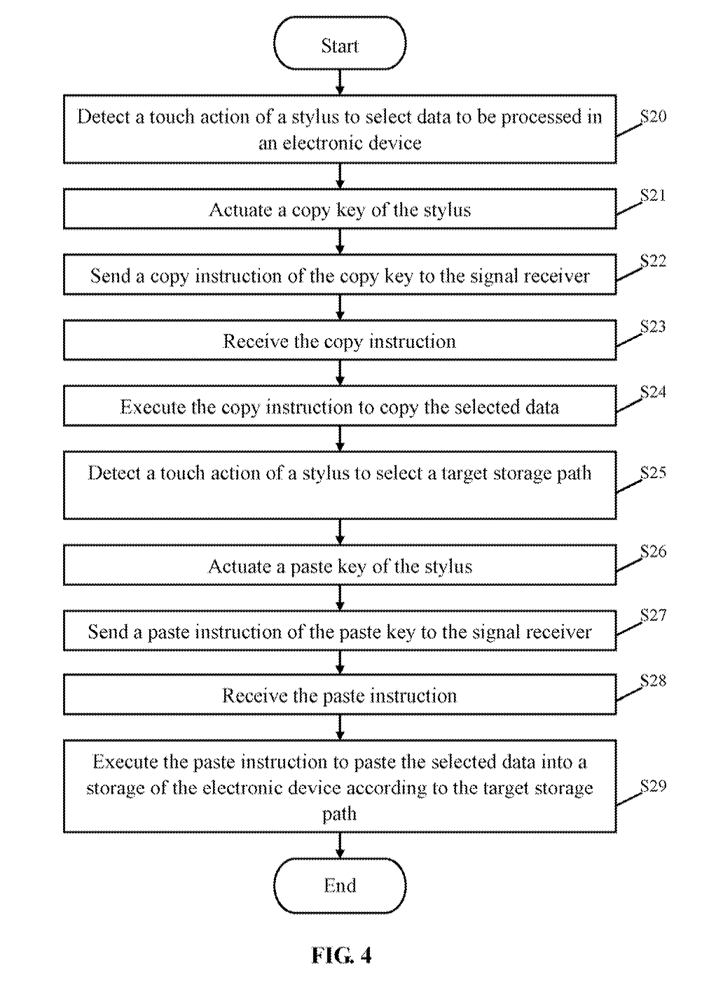

FIG. 4 is a flowchart of one embodiment of a method for copying data in the electronic device 1 of FIG. 1. Depending on the embodiment, additional blocks may be added, others removed, and the ordering of the blocks may be replaced.

In block S20, the detecting module 18 detects a touch action of the stylus 3 on the touch panel 10 to select data to be processed in the storage 16.

In block S21, a copy key has been actuated for copying the selected data.

In block S22, the signal sender 32 sends a copy instruction recorded in the copy key to the signal receiver 12.

In block S23, the signal receiver 12 receives the copy instruction from the signal sender 32.

In block S24, the executing module 19 executes the copy instruction to copy the selected data. For example, the executing module 19 may copy the selected data on a clipboard of the electronic device 1.

In block S25, the detecting module further detects a touch action of the stylus 3 on the touch panel 10 to select a target storage path (e.g., D:\).

In block S26, a paste key has been actuated.

In block S27, the signal sender 32 sends a paste instruction recorded in the paste key to the signal receiver 12.

In block S28, the signal receiver 12 receives the paste instruction.

In block S29, the executing module 19 executes the paste instruction to paste the selected data into the storage 16 according to the target storage path (e.g., D:\).

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for processing data in an electronic device, the electronic device comprising a touch panel, a stylus and a signal receiver, the stylus comprising a signal sender and one or more function keys recording preset instructions, the method comprising:
detecting a touch action of the stylus on the touch panel to select data to be processed in the electronic device;
sending a preset instruction recorded in an actuated function key of the stylus to the signal receiver in response that the function key has been actuated;
receiving the preset instruction by the signal receiver; and
executing the preset instruction to process the selected data.

2. The method according to claim 1, wherein the one or more function keys comprise a copy key recording a copy instruction, a paste key recording a paste instruction, a cut key recording a cut instruction, and/or a deletion key recording a deletion instruction.

3. The method according to claim 2, further comprising:
sending the copy instruction from the signal sender to the signal receiver in response that the copy key has been actuated; and
executing the copy instruction to copy the selected data.

4. The method according to claim 3, further comprising:
detecting a touch action of the stylus on the touch panel to select a target storage path.

5. The method according to claim 4, further comprising:
sending the paste instruction to the signal receiver in response that the paste key has been actuated; and
executing the paste instruction to paste the selected data into a storage of the electronic device according to the target storage path.

6. The method according to claim 1, wherein the one or more function keys are press keys or slide buttons.

7. An electronic device, the electronic device comprising:
a touch panel;
a stylus comprising a signal sender and one or more function keys recording preset instructions,
a signal receiver;
a storage;
at least one processor; and
one or more programs stored in the storage and being executable by the at least one processor, the one or more programs comprising a detecting module and an executing module;
the detecting module being operable to detect a touch action of the stylus on the touch panel to select data to be processed in the storage;
the signal sender being operable to send a preset instruction recorded in an actuated function key of the stylus to the signal receiver in response that the function key has been actuated;
the signal receiver being operable to receive the preset instruction from the signal sender; and
the executing module being operable to execute the preset instruction to process the selected data.

8. The electronic device according to claim 7, wherein the one or more function keys comprise a copy key recording a copy instruction, a paste key recording a paste instruction, a cut key recording a cut instruction, and/or a deletion key recording a deletion instruction.

9. The electronic device according to claim 8, wherein the signal sender sends the copy instruction to the signal receiver in response that the copy key has been actuated, and the executing module executes the copy instruction to copy the selected data.

10. The electronic device according to claim 9, wherein the detecting module is further operable to detect a touch action of the stylus on the touch panel to select a target storage path.

11. The electronic device according to claim 10, wherein the signal sender sends the paste instruction to the signal receiver in response that the paste key has been actuated, and the executing module executes the paste instruction to paste the selected data into the storage according to the target storage path.

12. The electronic device according to claim 7, wherein the one or more function keys are press keys or slide buttons.

13. A storage medium storing a set of instructions, the set of instructions capable of being executed by a processor to perform a method for processing data in an electronic device, the electronic device comprising a touch panel, a stylus and a signal receiver, the stylus comprising a signal sender and one or more function keys recording preset instructions, the method comprising:
detecting a touch action of the stylus on the touch panel to select data to be processed in the electronic device;
sending a preset instruction recorded in an actuated function key of the stylus to the signal receiver in response that the function key has been actuated;
receiving the preset instruction by the signal receiver; and
executing the preset instruction to process the selected data.

14. The storage medium as claimed in claim 13, wherein the one or more function keys comprise a copy key recording a copy instruction, a paste key recording a paste instruction, a cut key recording a cut instruction, and/or a deletion key recording a deletion instruction.

15. The storage medium as claimed in claim 14, wherein the method further comprises:
sending the copy instruction from the signal sender to the signal receiver in response that the copy key has been actuated; and
executing the copy instruction to copy the selected data.

16. The storage medium as claimed in claim 15, wherein the method further comprises:
detecting a touch action of the stylus on the touch panel to select a target storage path.

17. The storage medium as claimed in claim 16, wherein the method further comprises:
sending the paste instruction to the signal receiver in response that the paste key has been actuated; and
executing the paste instruction to paste the selected data into a storage of the electronic device according to the target storage path.

18. The storage medium as claimed in claim 13, wherein the one or more function keys are press keys or slide buttons.
